(19) United States
(12) Patent Application Publication
(10) Pub. No.: US 2012/0304185 A1
(43) Pub. Date: Nov. 29, 2012

(54) INFORMATION PROCESSING SYSTEM, EXCLUSIVE CONTROL METHOD AND EXCLUSIVE CONTROL PROGRAM

(75) Inventor: Takashi Horikawa, Minato-ku (JP)

(73) Assignee: NEC CORPORATION, Tokyo (JP)

(21) Appl. No.: 13/576,835

(22) PCT Filed: Jan. 19, 2011
(86) PCT No.: PCT/JP2011/000248

§ 371 Date: Aug. 2, 2012

(30) Foreign Application Priority Data
Feb. 3, 2010 (JP) 2010-021740

(51) Int. Cl. G06F 9/46

(52) U.S. Cl. 718/102

(57) ABSTRACT

Features of an information processing system include a stand-by thread count information updating means that updates stand-by thread count information showing a number of threads which wait for release of lock according to a spinlock method, according to state transition of a thread which requests acquisition of predetermined lock; and a stand-by method determining means that determines a stand-by method of a thread which requests the acquisition of the lock based on the stand-by thread count information updated by the stand-by thread count information updating means and an upper limit value of the number of threads which wait according to the predetermined spinlock method.

### TECHNICAL FIELD

This invention is concerning an information processing system, an exclusive control method and an exclusive control program which execute exclusive control.

### BACKGROUND ART

With an information processing system configured to execute a plurality of threads in parallel, execution of another processing by another thread interrupts at an arbitrary point of time when processing is executed by a thread. When these processings are irrelevant, even if another processing by another thread interrupts while a thread executes processing, a result does not change, and there is not a problem.

However, when these processings are relevant, if another processing by another thread interrupts while thread executes processing, a result varies, and there is a problem.

An example will be described where processing of adding 1 to the same variable by two threads (that is, processing of reading this variable, adding 1 to the variable and writing back a result) is executed. Meanwhile, a problem occurs when processing by another thread (processing of adding 1 to a variable) interrupts while one thread reads a variable and writes back a result of adding 1 to the variable.

When interruption does not occur, two threads execute an operation of adding 1 to each variable, and a value of the variable increase by 2. In view of content of processing executed by each thread, this processing result is correct.

However, when processing proceeds in an order that processing by another thread interrupts while thread executes processing by one thread, a value obtained by adding 1 to the original value is written back to the variable according to the first processing without detecting an update of the variable by interruption processing. Hence, even though the two threads execute an operation of adding 1 to the variable, the variable increases by 1 and therefore it is not possible to obtain the correct result.

Thus, a processing section in which a problem occurs when another processing interrupts during processing (a section in which data is read and a processed result is written back) is referred to as a “critical section”, and control for preventing interruption of another processing is explicitly executed.

When one processor executes a program, switching to another processing is forbidden at a point of time when the processor enters the critical section, and switching to another processing is allowed at a point of time when the processor gets out of the critical section, so that it is possible to guarantee that another processing does not interrupt during this section. In case of one processor, execution of another program (another thread) interrupts while a given program is executed as a thread, an event takes place which triggers switching the thread during execution of the first thread, and an operating system switches the thread. Consequently, by instructing the operating system to forbid switching to another processing (another thread), it is possible to execute control of switching a thread at a point of time when a first program allows switching to another processing (another thread) without switching the thread at a point of time when some event takes place which triggers switching the thread in a state where switching of the thread is forbidden.

Meanwhile, a multiprocessor system cannot guarantee that a correct processing result is obtained, only by forbidding switching to another processing. Although control for forbidding switching to another processing is effective for a processor which executes a program, this control does not influence execution of the program by another processor.

A method which is generally known for preventing execution of a program by another processor from entering a critical section is a measure of preparing for a flag (hereinafter, lock word) indicating whether or not there is a thread which is executing the critical section. In addition, in the following description, an execution right of the critical section (an access right to the critical section) is referred to as “lock”.

More specifically, a processor checks lock word at a point of time when a thread enters the critical section, and executes processing described in following 1) or 2). 1) If lock word is “a value (hereinafter, described as “unlocked”) indicating unused”, lock word is changed to “a value (hereinafter, described as “locked”) indicating used” and processing of a critical section is executed. Further, 2) if lock word is locked, a processor stands by until lock word becomes unlocked, changes lock word to locked and executes processing of the critical section. Furthermore, the processor returns lock word to unlocked at a point of time when execution of the critical section ends. By forming the above control, a problem does not occur that processing executed by another processing and processing executed by the processor compete in the critical section.

Only one thread described above can be executed in some critical sections, and the count of executable threads has an upper limit in some critical sections. Further, there is read-write lock including two types of lock including write clock (lock related to processing such as writing) and read lock (lock related to processing such as reading). Lock having an upper limit of the count of executable threads is regarded as a lock which can be executed by only one thread and is put into commercial use from a view point of an upper limit value of the count of executable threads. While the number of threads which can execute processing of a critical section by acquiring write lock is limited to 1 for read-write lock, the number of threads which can be executed at the same time does not have an upper limit value with read lock and, as long as there is no thread which executes processing by acquiring write lock, it is possible to execute processing of the critical section by acquiring read lock.

Next, a general waiting operation executed when control is executed to execute a critical section using lock will be described. At a point time when a given thread enters a critical section, if lock word is locked and execution of the critical section cannot be started immediately, this thread needs to stand by until lock word becomes unlocked. This method includes two types of methods described in following 1) and 2). 1) is a spinlock method (hereinafter, simply “spinlock”) where a thread continues checking lock word using a processor until lock word is changed to unlocked, and 2) is a block method (hereinafter, simply “block”) of requesting wake-up processing at a point of time when a thread stops using the processor and enters a sleep state (hereinafter, sleep) and when execution of the critical section is completed for a thread which is executing the critical section. Further, a method combining spinlock and block, that is, a method of standing by according to spinlock at first and standing by according to block as a time passes, is frequently used.

According to spinlock, a processor is used to execute processing of waiting for release of lock which is not the original processing requested by a thread, and therefore there is a drawback that consumption of processor resources increases. On the other hand, spinlock has an advantage that a time (handover time) from a point of time when a thread holding lock executes an operation of releasing lock to a point of time when a thread holding loop acquires lock and starts processing of a critical section is short. The advantage and the drawback of block are contrary to spinlock. More specifically, block has an advantage that use of the processor is stopped and, consequently, it is possible to reduce consumption of processor resources. On the contrary, block has a drawback that a time (handover time) from a point of time when a thread holding lock executes an operation of releasing lock to a point of time when the thread acquires lock and starts processing of the critical section is long. In addition, when the block method is adopted, a flag indicating that there is a stand-by thread is added as a variable for managing a state of the critical section in addition to lock word.

Even if waiting is executed according to any one of these methods, the original processing cannot be executed by a thread during waiting, and therefore effective use of capacity and performance of an information processing system is blocked.

Particularly, information processing systems in which multiple processors are generally mounted following a spread of multi-core processors in recent years are increasingly facing a situation where waiting for lock becomes a bottleneck of performance, and therefore a method of effectively waiting for lock is demanded.

For example, Patent Literature 1 discloses as a relevant technique a method of, when resources for which a lock request is made cannot be locked, determining a lock waiting method based on, for example, an average value of a lock time of the corresponding resources. Further, for example, Patent Literature 2 discloses a method of counting the number of instructions with respect to an exclusive control device, and limiting processing in a range in which the number of instructions does not exceed a threshold.

By the way, two operations of checking (reading) a value of lock word at a point of time when a thread enters a critical section, and changing (writing) unlocked to locked need to be handled in the same manner as the critical section. Hence, instructions for executing these operations are prepared for a processor having a function for a multi-processor.

For example, a cmpxchg instruction (see Non Patent Literature 1) is prepared for a x86 processor made by Intel (registered trademark) Corporation.

The cmpxchg instruction uses three operands of a register (eax register), a register operand and a memory operand reserved by an instruction. Further, the cmpxchg instruction atomically executes a series of operations of 1) reading a value of the memory operand in a processor, 2-1) when this value matches with a value of the eax register, writing a value of the register operand in a memory and 2-2) when this value does not match with the value of the eax register, writing this value in the eax register.

In addition, “atomic” means that it is guaranteed by a hardware operation that another processor does not access the memory between a memory reading operation in 1) and a memory writing operation in 2-1). Further, an operation executed according to this cmpxchg instruction is usually referred to as “Compare And Swap (CAS operation)”.

When a lock operation is executed using the above CAS instruction, the CAS instruction is executed by setting unlocked to the eax register and locked to the register operand, and setting the memory operand to lock word. When lock word is unlocked, above 2-1) processing is executed, and therefore lock word is rewritten to locked, and the value of the eax register does not change.

Meanwhile, when lock word is locked, above 2-2) processing is executed, writing in lock word is not executed, and locked is set to the eax register. A thread which executes the CAS instruction can check whether or not the lock operation succeeds or fails by checking the value of the eax register after executing the CAS instruction, and can decide based on success or failure whether to execute a critical section or enter a waiting state where unlocked is set to lock word.

A relevant technique other than a critical section is a memory managing technique (see non Patent Literature 2) providing user space and kernel space separately.

The user space is a memory area in which information (such as an instruction and data) required for an application program to operate is arranged, and includes an area independent for each thread. This space is generally a paging target, and is evacuated to a secondary memory device when a memory capacity is running short. Hence, in some cases, information arranged in the user space does not exist in a real memory.

Meanwhile, the kernel space is a memory area in which information required for a kernel (OS) which accesses a physical device or manages a system to operate is arranged, and is space which is shared between all threads.

Although it is possible to access data (hereinafter, “user data”) arranged in the user space during execution of a program in the user space (user mode), it is not possible to access data (hereinafter, kernel data) arranged in the kernel space. Further, during execution of a program in the kernel space (kernel mode), it is possible to access data arranged in the kernel space and the user space belonging to a thread which is executing the program.

Upon accessing user data during execution of a program according to the kernel mode, access target data may not exist in the real memory, and therefore it is necessary to accurately operate a system even in this situation. Hence, using a user space reading means and a user space writing means prepared as kernel functions, data is copied between the user space and the kernel space. When processing user data, the kernel executes processing in an order that the user space reading means copies this data to the kernel space and then processes the data, and the user space writing means returns this result to the user space.

An access from the kernel to user data is executed by the user space reading means and the user space writing means. Hence, when lock word is arranged in the user space, the kernel has no means for atomically executing a reading operation and a writing operation for lock word, and an atomic access to lock word, that is, an operation of acquiring an access right to a critical section, is generally executed according to a program in the user space.

### CITATION LIST

### Patent Literature

PTL 1: Patent 2001-084235

PTL 2: Patent 2002-312185

### Non Patent Literature

NPL 1: Intel 64 and IA-32 Architectures Software Developer's Manual Volume 2A: Instruction Set Reference, A-M, [Searched on Jan. 26, 2010], Internet <URL:http://www.intel.com/Assets/PDF/manual/253666.pdf>

NPL 2: “THE DESIGN OF THE UNIX OPERATING SYSTEM”, Maurice J. Bach, PRENTICE-HALL, INC., Englewood Cliffs, N.J. 07632, 1986

In addition, UNIX is a registered trademark.

### SUMMARY OF INVENTION

### Technical Problem

However, with a multiprocessor system which waits for release of lock according to spinlock or a method combining spinlock and block, if lock competition becomes intense, the number of processors which wait for release of lock according to spinlock increases and, as a result, processor resources are wasted.

This is because, when a given thread transitions to a lock waiting state, there is no means that checks the number of threads which wait for release of lock according to spinlock, and therefore the thread waits for release of lock according to spinlock even when the spinlocked thread count exceeds the adequate number for this lock.

Further, the method disclosed in Patent Literature 1 or Patent Literature 2 includes selecting a method of waiting for release of lock based on a threshold found in advance, and therefore cannot select a method of efficiently waiting for release of lock according to a situation at a point of time when acquisition of lock is requested.

It is therefore an object of this invention to provide an information processing system, an exclusive control method and an exclusive control program which can prevent processor resources from being wasted when multiple threads wait for release of lock according to the spinlock method.

### Solution to Problem

An information processing system according to the present invention is characterized in including: a stand-by thread count information updating means that updates stand-by thread count information showing a number of threads which wait for release of lock according to a spinlock method, according to state transition of a thread which requests acquisition of predetermined lock; and a stand-by method determining means that determines a stand-by method of a thread which requests the acquisition of the lock based on the stand-by thread count information updated by the stand-by thread count information updating means and an upper limit value of the number of threads which wait according to the predetermined spinlock method.

An exclusive control method according to the present invention is characterized in including: updating stand-by thread count information showing a number of threads which wait for release of lock according to a spinlock method, according to state transition of a thread which requests acquisition of predetermined lock; and determining a stand-by method of a thread which requests the acquisition of the lock based on the stand-by thread count information and an upper limit value of the number of threads which wait according to the predetermined spinlock method.

An exclusive control program according to the present invention is characterized in causing a computer to execute: stand-by thread count information updating processing of updating stand-by thread count information showing a number of threads which wait for release of lock according to a spinlock method, according to state transition of a thread which requests acquisition of predetermined lock; and stand-by method determining processing of determining a stand-by method of a thread which requests the acquisition of the lock based on the stand-by thread count information and an upper limit value of the number of threads which wait according to the predetermined spinlock method.

### Advantageous Effects of Invention

According to this invention, it is possible to prevent processor resources from being wasted when multiple threads wait for release of lock according to a spinlock method.

### BRIEF DESCRIPTION OF DRAWINGS

FIG. 1 illustrates an explanatory view that illustrates a configuration example of an information processing system according to this invention.

FIG. 2 illustrates an explanatory view that illustrates an example of exclusive control data (lock word) 221.

FIG. 3 illustrates an explanatory view that illustrates an example of a flow of a program and data.

FIG. 4 illustrates a flowchart that illustrates operation examples of a user space reading processing means 231, a user space writing means 232 and a user space atomic accessing means 233.

FIG. 5 illustrates a transition diagram that illustrates state transition of a thread.

FIG. 6 illustrates a flowchart that illustrates an operation example of lock acquisition processing.

FIG. 7 illustrates a flowchart that illustrates an operation example of lock release processing.

FIG. 8 illustrates a flowchart that illustrates an operation example of a lock acquiring operation in lock acquisition processing.

FIG. 9 illustrates a flowchart that illustrates an operation example of a sleep operation in lock acquisition processing.

FIG. 10 illustrates a flowchart that illustrates an operation example of lock release processing.

FIG. 11 illustrates a flowchart that illustrates an operation example of thread wake-up processing in lock release processing.

FIG. 12 illustrates a functional block diagram that illustrates a function configuration example of an information processing system.

FIG. 13 illustrates a block diagram that illustrates a minimum configuration example of the information processing system.

### DESCRIPTION OF EMBODIMENTS

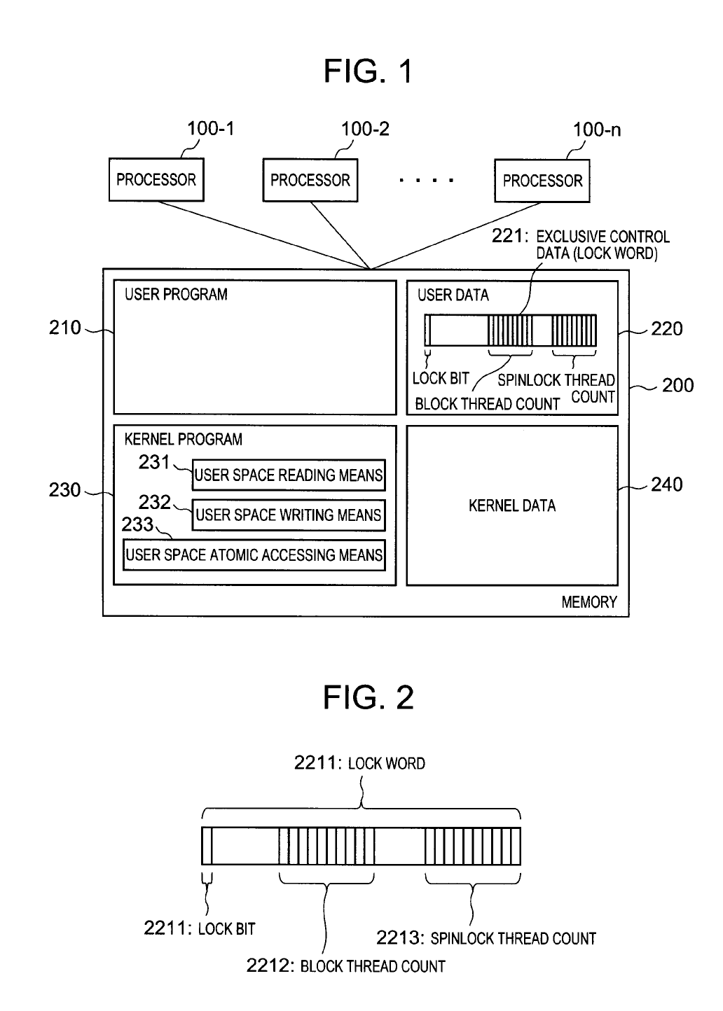

Next, an embodiment of this invention will be described with reference to the drawings. FIG. 1 illustrates an explanatory view that illustrates a configuration example of an information processing system according to this invention. Referring to FIG. 1, the information processing system according this invention has a plurality of processors (central processing units) 100-1 to 100-n , and a memory 200. In addition, the information processing system is realized specifically by an information processing device such as a server or a personal computer which operates according to a program.

The memory 200 includes areas for recording a user program 210, user data 220, a kernel program 230 and kernel data 240. Further, the kernel program 230 includes a user space reading means 231, a user space writing means 232 and a user space atomic accessing means 233 that access the user data 220.

Meanwhile, the user space atomic accessing means 233 has a function of atomically accessing lock word 221 as described below. Further, the user space reading means 231 and the user space writing means 232 has functions equivalent to a common technique. More specifically, the user space reading means 231 has a function of reading data arranged in the user data 220 and copying the data to the kernel data 240. Further, the user space writing means 232 has a function of, for example, writing data arranged in the kernel data 240, in the user data 220.

In addition, an access from the user program 210 to the user data 220 or an access from the kernel program 230 to the kernel data 240 are not limited similar to common information processing systems. That is, each of the processors 100-1 to 100-n can read, write and atomically access a machine language instruction of a processor without using a specially provided means.

These means roughly operate as follows. Each of the processors 100-1 to 100-n generates one or more threads (not illustrated). Each thread reads a machine language instruction to be executed, from the user program 210 or the kernel program 230, and executes processing defined according to this machine language instruction. In this case, each thread uses the user data 220 or the kernel data 240 where necessary. An expression that a thread or a program executes processing is employed below with this embodiment, and, more specifically, the processor 100 executes processing according to the user program 210 or the kernel program 230.

FIG. 2 illustrates an explanatory view that illustrates an example of the exclusive control data (lock word) 221. Referring to FIG. 2, the lock word 221 according to this embodiment includes information showing lock bit 2211, the spinlock thread count 2213 and the block thread count 2212. The lock bit 2211 indicates whether or not there is a thread which holds lock matching the lock word 221 and is executing the critical section. The spinlock thread count 2213 indicates the number of threads which wait for release of lock according to spinlock. The block thread count 2212 indicates the number of threads which wait for release of lock according to block. Further, this lock word 221 has a data length handled by an atomic operation such as a CAS operation provided by the processor 100.

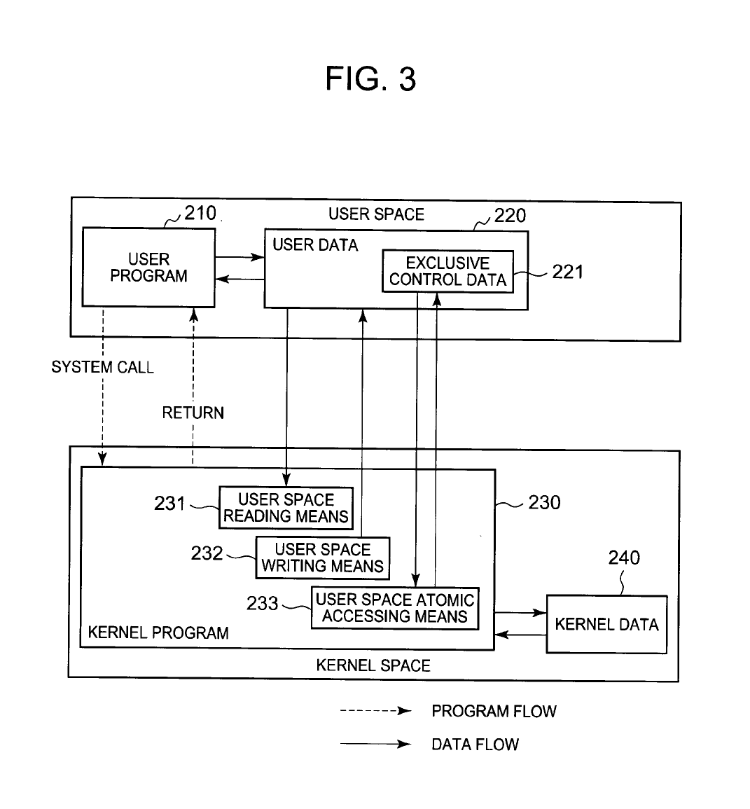

FIG. 3 illustrates an explanatory view that illustrates an example of a flow of a program and data. As illustrated in FIG. 3, the user program 210 transitions to the kernel mode by making a system call when using the function of the kernel program 230, and then executes processing according to the kernel program 230. Further, when processing according to the kernel program 230 is finished, the kernel program 230 returns to the user program 210 back to the user mode, and then continues processing of the user program 210.

The kernel program 230 uses the user space reading means 231, the user space writing means 232 or the user space atomic accessing means 233 according to a type of an access when using the user data 220.

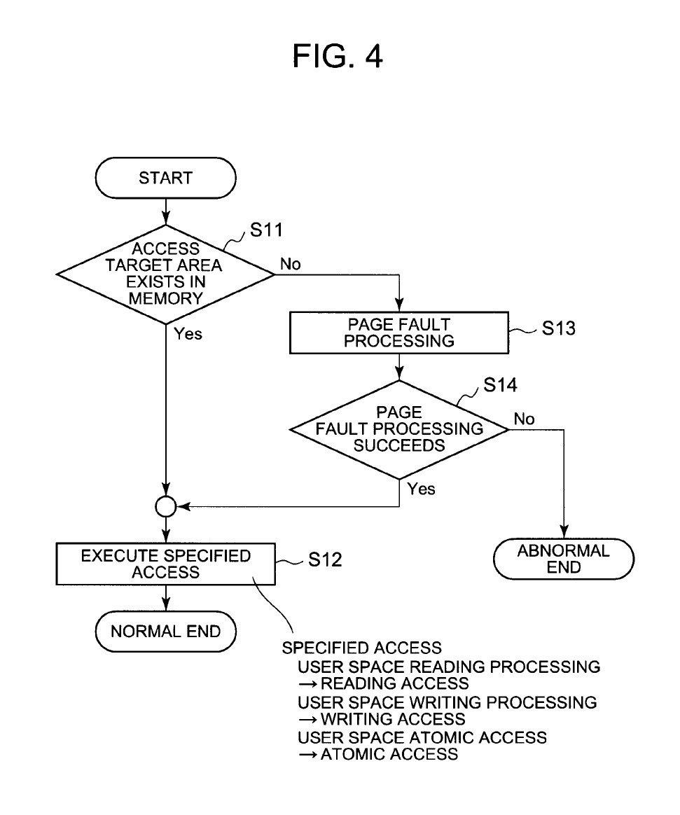

Next, an operation when each means included in the kernel program 230 accesses the user data 220 will be described using FIG. 4. FIG. 4 illustrates a flowchart that illustrates operation examples of the user space reading processing means 231, the user space writing means 232 and the user space atomic accessing means 233.

Referring to FIG. 4, the kernel program 230 (the user space reading means 231, the user space writing means 232 or the user space atomic accessing means 233) first decides whether or not there is an access target area in a memory (step S11).

When deciding that there is the access target area, the kernel program 230 executes the specified access processing (step S12). That is, in case of user space reading processing, the kernel program 230 executes a reading access using the user space reading means 231. Further, in case of user space writing processing, the kernel program 230 executes a writing access using the user space writing means 232. In case of a user space atomic access, the kernel program 230 executes an atomic access using the user space atomic accessing means 233.

Subsequently, the kernel program 230 (the user space reading means 231, the user space writing means 232 or the user space atomic accessing means 233) finishes processing of accessing the user space.

Meanwhile, when deciding that there is no access target area in the memory, the kernel program 230 executes page fault processing, and then returns the memory area which is evacuated to a secondary memory device to the real memory (step S13).

Next, the kernel program 230 decides whether or not page fault processing succeeds (step S14), and, when deciding that the processing succeeds, transitions processing to step S12, executes an access according to the specified processing and then finishes processing of accessing the user space. Further, when deciding that the page fault processing does not succeed, the kernel program 230 abnormally ends assuming that processing of accessing the user space fails.

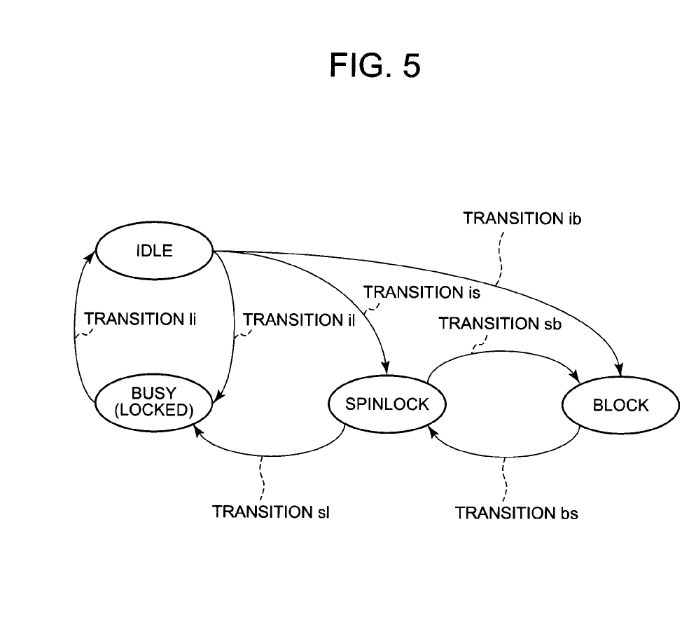

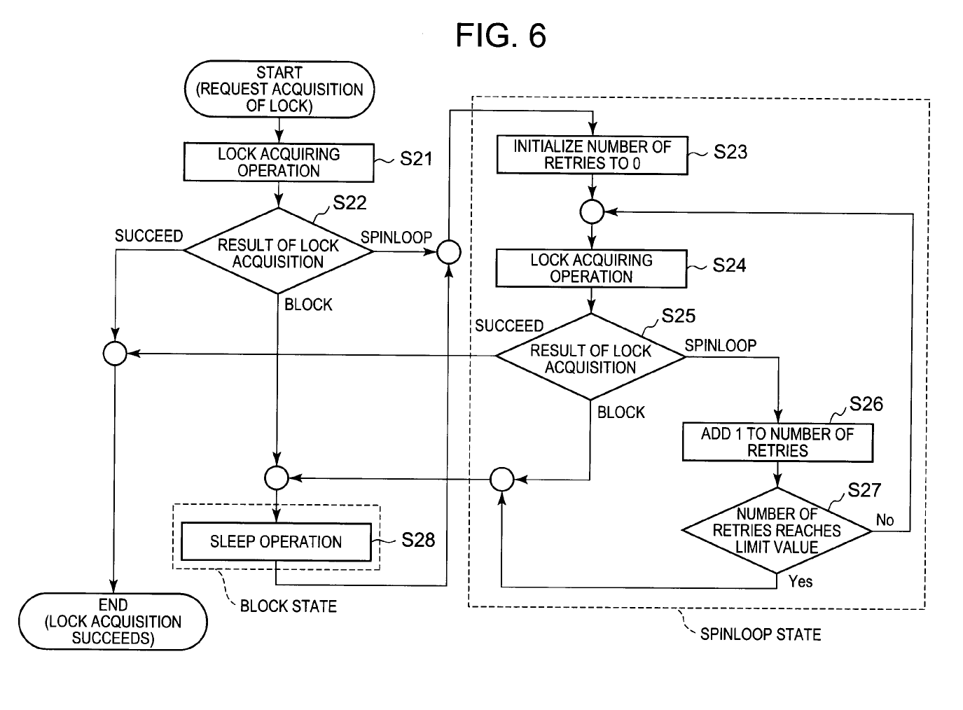

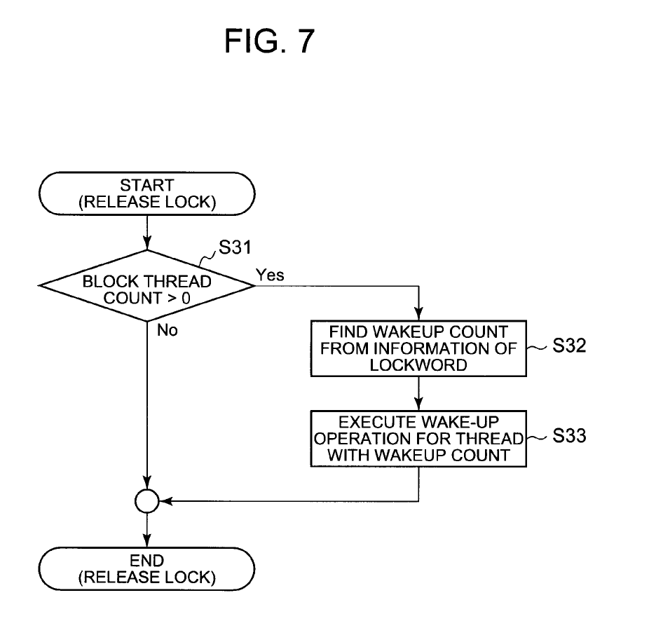

Next, an entire operation of the information processing device to which the exclusive control method according to this embodiment is applied will be described with reference to a state transition diagram of FIG. 5, and flowcharts of FIGS. 6 and 7.

FIG. 5 illustrates a transition diagram that illustrates state transition of a thread. Referring to FIG. 5, states of threads which are operating in this information processing device with respect to lock include four states of a no lock request (hereinafter, described as “idle”) state, a lock acquisition (hereinafter, described as “busy (locked)” and an index indicating a state in FIG. 5 is 1) state, a lock release waiting state according to spinlock and a lock release waiting state according to block. Further, the states which are likely to transition to a plurality of states are the idle state and the spinlock state.

A transition destination from the idle state, that is, a state transition destination when a thread which does not acquire lock requests acquisition of lock is one of the following three types according to the lock state indicated by lock word. 1) When there is no thread which acquires lock, a thread transitions from the idle state to the busy (locked) state (transition il). 2) When another thread acquires lock and the spinlock thread count is less than an upper limit value, the thread transitions from the idle state to the spinlock state (transition is). 3) When another thread acquires lock and when the spinlock thread count is an upper limit value or more, the thread transitions from the idle state to the block state (transition ib).

The transition destination from the spinlock state is determined based on the following conditions. 1) When a thread which has acquired lock releases lock during spinlock, a thread transitions from the spinlock state to the busy (locked) state (transition s1). 2) When lock is not released even after a predetermined period for spinlock passes, a thread transitions from the spinlock state to the block state (transition sb).

Further, a thread transitions from the block state to the spinlock state according to wake-up processing executed when a thread which has acquired lock releases lock (transition bs). Furthermore, according to an operation of releasing acquired lock from the busy (locked) state, a thread transitions to the idle state (transition li). Every state transition is finished when an operation of reflecting the lock word state ends.

Next, lock acquisition processing will be described. FIG. 6 illustrates a flowchart that illustrates an operation example of lock acquisition processing. Referring to FIG. 6, according to the lock acquisition processing, a lock acquiring operation is executed first (step S21), a predetermined operation is executed according to a result of the lock acquisition processing (step S22), lock is finally acquired and then the lock acquisition processing is finished. In addition, acquisition of lock means acquiring an execution right of a critical section (an access right to the critical section), and, more specifically, means that the thread changes the lock bit 2211 of the lock word 221 from unlocked to locked.

That is, when a thread which requests acquisition of lock executes the lock acquiring operation (details will be described), the thread transitions from the idle state to one of the busy (locked) state, the block state and the spinlock state according to the result of the lock acquiring operation. More specifically, a thread determines a state transition destination based on each of the above conditions described by using the transition diagram illustrated in FIG. 5.

When lock is successfully acquired as a result of the lock acquiring operation, the thread transitions to the busy (locked) state, and finishes the lock acquisition processing. Then, the thread executes the critical section.

Further, when the thread transitions to the spinlock state as a result of the lock acquiring operation, the thread initializes the number of retries (for example, stored in a register) to 0 in case of failure of lock acquisition (step S23), and then further executes the lock acquiring operation (step S24).

When lock is successfully acquired as a result of this or an execution result of the lock acquiring operation is “transition to block” (details will be described below), the thread makes the same transition similar to decision in step S22 (step S25).

Further, when the result of the lock acquiring operation in step S24 is “transition to the spinlock state” (details will be described below), the thread adds 1 to the number of retries (step S26). Subsequently, the thread decides whether or not the number of retries reaches a limit value of the number of retries (for example, determined in advance according to a SPIN_LIMIT value described below) (step S27).

In step S27, when deciding that the number of retries reaches the limit value, the thread transitions from the spinlock state to the busy (locked) state. Meanwhile, when deciding that the number of retries does reach the limit value, the thread transitions to processing of the lock acquiring operation (step S24) in the spinlock state again, and enters a spinloop state of repeating the subsequent processing. In addition, as illustrated in FIG. 6, with this embodiment, a state where a thread repeats the lock acquiring operation in the spinlock state is referred to as the “spinloop” state.

The thread which transitions to the block state in step S22 or step S25 wakes up according to the wake-up operation executed when another thread which has acquired lock releases lock, and transitions from the block state to the spinloop state (step S28). That is, the thread transitions processing to step S23 according to the wake-up operation.

Next, lock release processing will be described. FIG. 7 illustrates a flowchart that illustrates an operation example of lock release processing. In addition, release of lock means releasing an execution right of a critical section which is being acquired (an access right to the critical section) and, more specifically, means that a thread changes the lock bit 2211 of the lock word 221 from locked to unlocked.

Referring to FIG. 7, according to processing of releasing lock by a thread in the busy (locked) state, the thread first executes a lock releasing operation. That is, the thread changes lock bit in lock word to unlocked. Subsequently, the thread checks the block thread count, and decides whether or not the block thread count is greater than 0 (step S31).

When deciding that the block thread count is greater than 0, the thread finds the wakeup count (the number of threads which execute wakeup (wake-up operation) from information in lock word (for example, WAKEUP_LIMIT value described below) (step S32). In addition, a specific method of finding the wakeup count will be described below.

Next, the thread executes the wake-up operation for another thread with the wakeup count in the block state (step S33), and finishes the lock release processing. In addition, when deciding in step S31 that the block thread count is 0, the thread finishes the lock release processing immediately.

Features of this embodiment include the following two points. The first feature includes that, when lock cannot be acquired in the lock acquiring operation, a thread transitions to the block state or the spinloop state according to a result of the lock acquiring operation. Further, the second feature includes that, when there is a thread which is in the block state when lock is released, the number of threads which are wake-up operation targets is determined from information of lock word, and the wake-up operation is executed.

Next, an operation according to this embodiment will be described using a specific example. As illustrated in FIG. 2, the lock word 221 according to this embodiment includes the lock bit 2211 of 1 bit, the block thread count 2212 of 10 bits and the spinlock thread count 2213 of 10 bits. Meanwhile, the lock bit 2211 means unlocked in case of 0, and means locked in case of 1. Further, this lock word 221 is a CAS instruction or a data length for which the user space atomic accessing means can execute the CAS operation.

Furthermore, in the following description, variables having the same data length and data structure as lock word are used as variables old and new. Still further, the CAS instruction and the CAS operation of the user space atomic accessing means are executed by setting the variable old to the eax register, the variable new to the register operand and an address of lock word to the memory operand. Moreover, with this embodiment, an upper limit value of the number of threads which wait for release of lock according to spinlock and an upper limit value of the number of threads which has released lock and wake up are set in advance as fixed values, and are a SPIN_LIMIT value and a WAKEUP_LIMIT value, respectively.

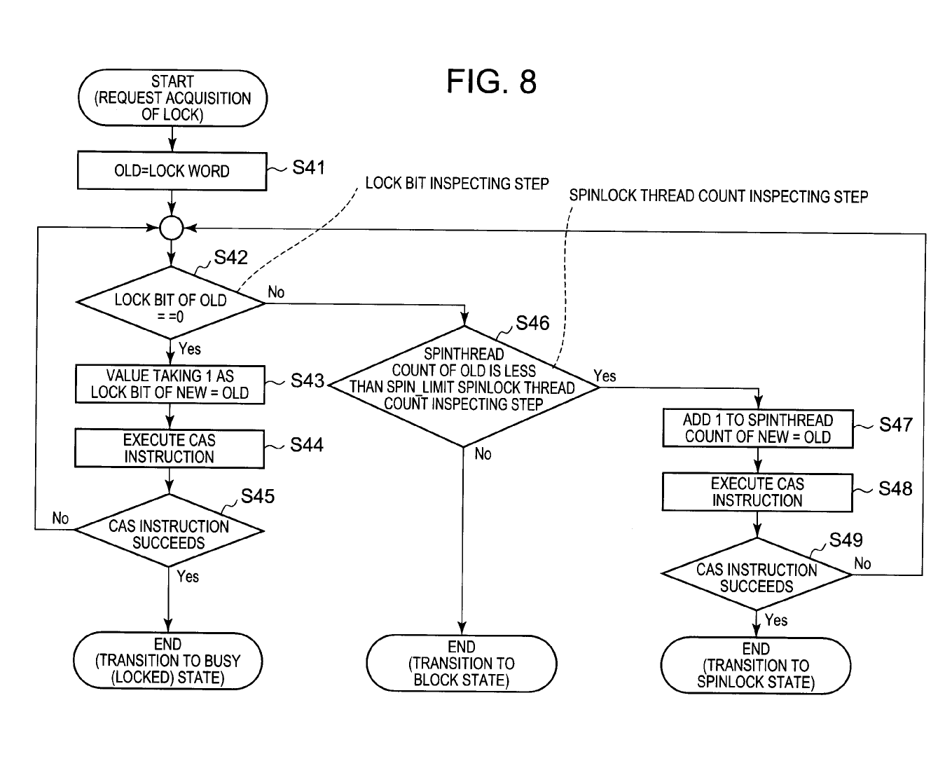

The lock acquisition processing will be described first. FIG. 8 illustrates a flowchart that illustrates an operation example of a lock acquiring operation in lock acquisition processing. As illustrated in FIG. 8, the lock acquiring operation according to this embodiment operates as follows.

According to the lock acquiring operation, a thread substitutes lock word in old (step S41), and decides whether or not lock bit of old is 0 (step S42: lock bit inspecting step).

When deciding that lock bit of old is 0, the thread sets a value which takes 1 as lock bit of old, to new (step S43), and executes the CAS instruction (step S44).

Next, the thread decides whether or not the CAS instruction succeeds (step S45). When deciding that the CAS instruction succeeds, this means that lock is successfully acquired, the thread regards an execution result of the lock acquiring operation as “transition to the busy (locked) state” (corresponding to “succeed” in FIG. 6), and finishes the lock acquiring operation.

Further, when deciding that the CAS instruction fails, a lock word value read from the memory is set to old as the operation of the CAS instruction, and the thread transitions processing to the lock bit inspecting step (step S42), and executes the subsequent processing again.

When deciding that lock bit is 1 (that is, lock is acquired by another thread) as a result of the lock bit inspecting step (step S42), the thread compares the spinlock thread count of old and the SPIN_LIMIT value (step S46: the spinlock thread count inspecting step).

When the spinlock thread count is less than SPIN_LIMIT as a result of comparison, the thread sets to new a value obtained by adding 1 to the spinlock thread count of old (step S47), and executes the CAS instruction (step S48). Next, when the thread decides whether or not the CAS instruction succeeds (step S49) and the CAS instruction succeeds, the thread regards the execution result of the lock acquiring operation as “transition to the spinlock state”, and finishes the lock acquiring operation.

Meanwhile, when deciding that the spinlock thread count is not less than SPIN_LIMIT as a result of comparison in the spinlock thread count inspecting step (step S46), the thread regards the execution result of the lock acquiring operation as “transition to the block state”, and finishes the lock acquiring operation.

When the result of the lock acquiring operation illustrated in FIG. 8 is “transition to the spinlock state”, the thread transitions from the id state to the spinlock state, and operates according to a flow indicated as the spinloop state in FIG. 6.

Further, when the result of the lock acquiring operation is “transition to the block state”, the thread transitions from the state to the block state, and executes the sleep operation.

Next, the sleep operation in the lock acquisition processing will be described. In addition, processing of the sleep operation according to this embodiment is implemented according to the kernel program, and is activated according to a system call prepared to execute the sleep operation in the block state. Further, the sleep state refers to a state where a thread stops using processor resources.

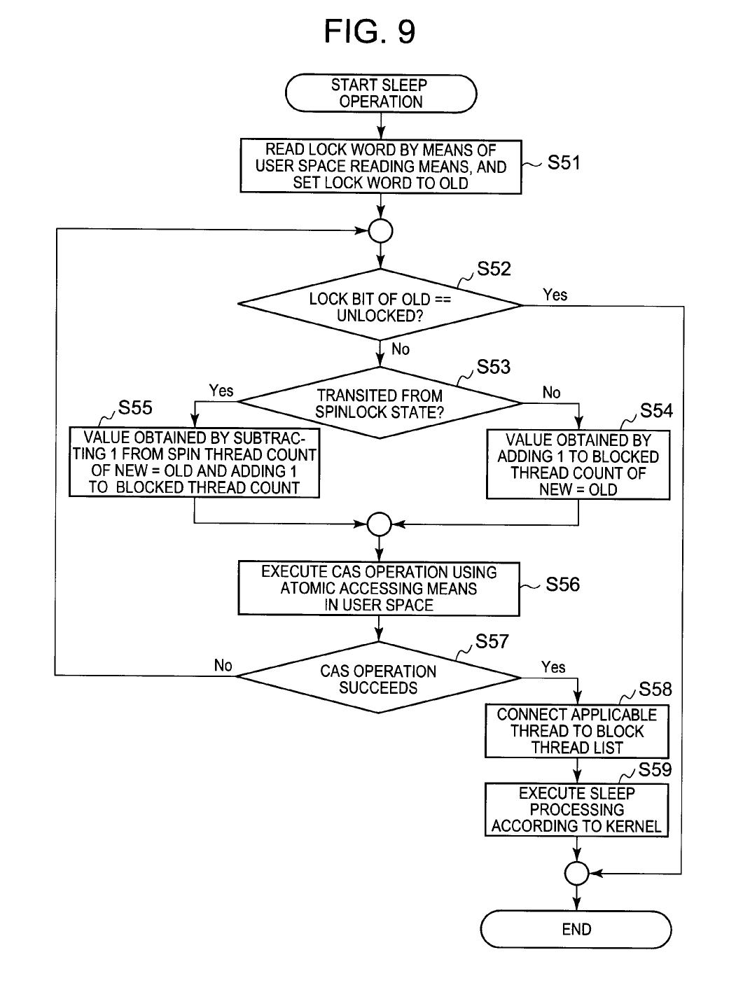

FIG. 9 illustrates a flowchart that illustrates an operation example of a sleep operation in lock acquisition processing. As illustrated in FIG. 9, the sleep operation according to this embodiment is executed as follows.

First, the thread activates a system call to execute the sleep operation, and transitions to the kernel mode. Next, the thread reads lock word arranged in the user space using the user space reading means, and sets lock word to old (step S51).

Next, the thread decides whether or not lock bit of old is unlocked (step S52), and does not need to sleep when deciding that lock bit is unlocked and finishes the sleep operation itself. That is, the thread finishes the system call, and returns to the user mode.

When deciding in step S52 that lock bit is not unlocked, that is, when lock bit is locked, the thread decides the state of the transition source (step S53), and sets new according to the state of the transition source.

More specifically, when the thread transitions directly from the idle state, the thread uses as a value of new a value obtained by adding 1 to the block thread count of old (step S54).

Further, when the thread transitions from the spinloop state, the thread reduces 1 from spinloop count of old, and further uses as a value of new a value obtained by adding 1 to the block thread count (step S55).

Next, the thread executes the CAS operation using the user space atomic accessing means (step S56).

Next, when deciding whether or not the CAS operation succeeds (step S57) and deciding when this CAS operation fails, the thread transitions processing to step S52 of checking lock bit, and executes processing subsequent to step S52 again.

Meanwhile, when deciding that the CAS operation succeeds, the thread is connected to the block thread list (step S58), executes sleep processing of the kernel (stops using processor resources) and transitions to the sleep state (step S59). In addition, the block thread list is similar to a common technique, and is used to extract a thread in the sleep state in the wakeup operation. Further, this sleep state is lifted when another thread which has acquired lock finishes execution of a critical section, and executes the lock release processing.

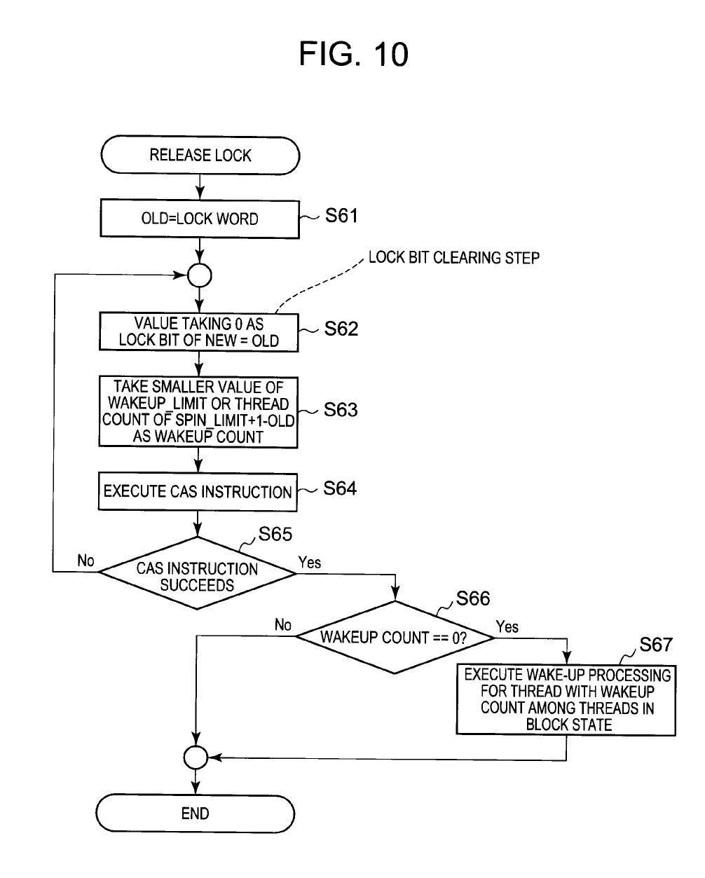

Next, the lock release processing will be described. FIG. 10 illustrates a flowchart that illustrates an operation example of lock release processing. As illustrated in FIG. 10, in the lock release processing according to this embodiment, the thread operates as follows.

First, the thread substitutes lock word in old (step S61), and sets a value obtained by taking 0 for lock bit of old, to new (step S62: lock bit clearing step).

Next, the thread sets the wakeup count based on the WAKEUP_LIMIT value, the SPIN_LIMIT value and the spinlock thread count of old (step S63). More specifically, the thread compares the WAKEUP_LIMIT value and the spin thread count of the SPIN_LIMIT+1-old, and takes a smaller value as the wakeup count.

Next, the thread executes the CAS instruction (step S64), and decides whether or not the CAS instruction succeeds (step S65).

When deciding that the CAS instruction fails, the lock word value read from the memory is set to old according to the operation of the CAS instruction, and therefore the thread transitions processing to the lock bit clearing step (step S62), and executes processing subsequent to step S62 again.

When deciding that the CAS instruction succeeds, the thread checks the wakeup count (step S66), and then finishes lock release processing when the value of the wakeup count is 0. Further, when the wakeup count is not 0, the thread executes wake-up processing for a thread with the wakeup count among other threads in the block state, and finishes lock release processing (step S67).

Next, wakeup processing for another thread in the lock release processing will be described. In addition, the wake-up processing according to this embodiment is implemented as the kernel program, and activated by a system call prepared to execute the wake-up operation for a thread in the block state.

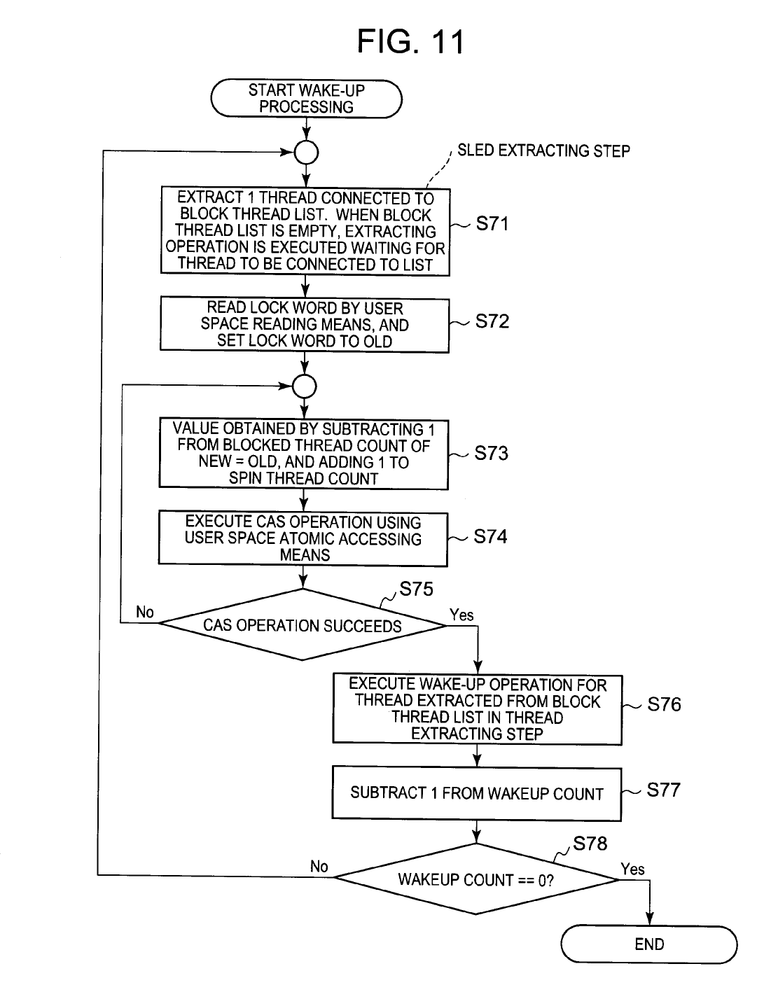

FIG. 11 illustrates a flowchart that illustrates an operation example of thread wake-up processing in lock release processing. As illustrated in FIG. 11, the wake-up processing according to this embodiment operates as follows.

First, the thread activates the system call for executing the wake-up processing, and transitions to the kernel mode. Next, the thread extracts one thread connected to the block thread list. When the block thread list is empty, the thread executes an extracting operation until the thread is connected to this list (step S71: thread extracting step).

Next, the thread reads lock word arranged in the user space using the user space reading means, and sets lock word to old (step S72).

Subsequently, the thread uses as a value of new a value obtained by subtracting 1 from the block thread count of old and further adding 1 to the spinlock thread count (step S73), and executes the CAS operation using the user space atomic accessing means (step S74).

Next, the thread decides whether or not the CAS operation succeeds (step S75), transitions processing to step S73 of setting a value to new based on the old value when deciding that the CAS operation fails, and executes the subsequent processing again.

When deciding that the CAS operation succeeds, the thread executes the wake-up operation for a thread extracted from the block thread list in a thread extracting step (step S71) (step S76). Subsequently, the thread repeats this wake-up operation a number of times specified based on the wakeup count, and finishes the wake-up processing.

More specifically, after executing processing in step S76, the thread subtracts 1 from the wakeup count (step S77). Next, when deciding whether or not the wakeup count is 0 (step S78) and deciding that the wakeup count is not 0, the thread transitions processing to step S73, and executes processing subsequent to step S73 again.

Meanwhile, when deciding that the wakeup count is 0, the thread finishes the wake-up processing. That is, the thread finishes the system call, and returns to the user mode.

As described above, with this embodiment, lock word indicating whether or not there is a thread which is executing a critical section includes information showing the number of threads which wait for release of lock according to spinlock, and the number of threads which wait for release of lock according to block. Further, these pieces of information are used when four states related to lock of the thread, that is, when the thread transitions between a no lock request state, a lock acquisition state, a lock release waiting state according to spinlock and a lock release waiting state according to block, and each information is updated according to state transition.

Thus, with this embodiment, a method is selected of accurately counting the degree of competition at a point of time of a request using an atomic memory access function, and waiting for release of lock based on the counted information. Consequently, it is possible to make the number of threads which wait for release of lock according to spinlock an upper limit value or less set in advance, based on a situation at a point of time when acquisition of lock is requested. Consequently, it is possible to prevent threads equal to more than the required count from waiting for release of lock according to spinlock, and prevent processor resources from being wasted due to waiting according to spinlock.

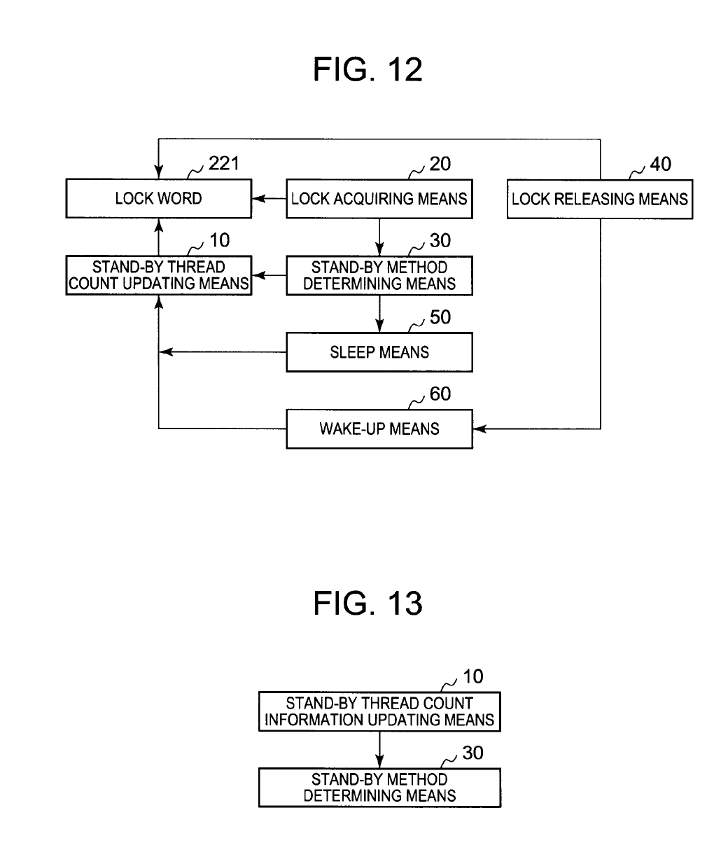

Next, a function configuration of the information processing system according to this embodiment will be described. FIG. 12 illustrates a functional block diagram that illustrates a function configuration example of an information processing system.

As illustrated in FIG. 12, the information processing system includes a waiting thread count information updating means 10, a lock acquiring means 20, a stand-by method determining means 30, a lock releasing means 40, a sleep means 50, a wake-up means 60 and the exclusive control data (lock word) 221.

The stand-by thread count information updating means 10 is realized specifically by the processor 100 which operates according to the user program 210 or the kernel program 230. The stand-by thread count information updating means 10 has a function of updating the lock word 221 according to state transition of a thread which requests acquisition of predetermined lock. Further, the stand-by thread count information updating means 10 has a function of updating the lock word 221 arranged in the user space from the kernel space using the user space atomic accessing means.

The lock acquiring means 20, the stand-by method determining means 30 and the lock releasing means 40 are realized specifically by the processor 100 which operates according to the user program 210.

The lock acquiring means 20 has a function of acquiring lock of predetermined resources. More specifically, the lock acquiring means 20 decides whether or not lock of target resources is acquired, based on the lock bit 2211 of the lock word 221, and acquires lock and updates the lock bit 2211 to locked when the lock bit 2211 is unlocked.

The stand-by method determining means 30 has a function of determining a stand-by method where the thread which requests acquisition of lock waits for release of lock acquired by another thread. More specifically, the stand-by method determining means 30 determines the stand-by method based on the spinlock thread count 2213 of the lock word 221 and an upper limit value (for example, the SPIN_LIMIT value) of the number of threads which stand by according to the spinlock method set in advance.

The lock releasing means 40 has a function of releasing acquired lock. More specifically, the lock releasing means 40 releases lock, and changes the lock bit 2211 of the lock word 221 to unlocked. Further, the lock releasing means 40 makes the wake-up means 60 execute the wake-up processing when releasing lock.

The sleep means 50 and the wake-up means 60 are realized specifically by the processor 100 which operates according to the kernel program 230.

The sleep means 50 has a function of executing the sleep operation for the thread. More specifically, the sleep means 50 transitions the thread to the stand-by state according to the block method. Further, the sleep means 50 updates information of the lock word 221 using the user space atomic accessing means 233 when transitioning the thread to the sleep state (block state). For example, the sleep means 50 makes the stand-by thread count updating means 10 update the information of the lock word 221 using the user space atomic accessing means 233.

The wake-up means 60 has a function of executing the wake-up processing for the thread in the sleep state (block state). More specifically, the wake-up means 60 transitions the thread from the stand-by state according to the block method to the stand-by state according to the spinlock method. Further, the wake-up means 60 updates the information of the lock word 221 using the user space atomic accessing means 233 when executing the wake-up processing. For example, the wake-up means 60 makes the stand-by thread count updating means 10 update the information of the lock word 221 using the user space atomic accessing means 233.

Next, a minimum configuration of the information processing system according to this invention will be described. FIG. 13 illustrates a block diagram that illustrates a minimum configuration example of the information processing system according to this invention. As illustrated in FIG. 13, the information processing system includes the stand-by thread count information updating means 10 and the stand-by method determining means 30 as minimum components.

With the information processing system employing the minimum configuration illustrated in FIG. 13, the stand-by thread count information updating means 10 updates stand-by thread count information showing the number of threads which wait for release of lock according to state transition of a thread which requests acquisition of predetermined lock. Further, the stand-by method determining means 30 determines a stand-by method of a thread which requests acquisition of lock based on stand-by thread count information updated by the stand-by thread count information updating means 10.

Consequently, the information processing system employing the minimum configuration can select a method of efficiently waiting for release of lock according to a situation at a point of time when requesting acquisition of lock, and prevent processor resources in a state where release of lock is waited from being wasted.

In addition, with this embodiment, characteristic configurations of the information processing system as described in following (1) to (6) are described.

(1) Features of an information processing system include: a stand-by thread count information updating means (realized by, for example, the stand-by thread count information updating means 10) that updates stand-by thread count information (for example, the lock word 221) showing the number of threads which wait for release of lock according to a spinlock method, according to state transition of a thread which requests acquisition of predetermined lock; and a stand-by method determining means (realized by, for example, the stand-by method determining means 30) that determines a stand-by method of a thread which requests the acquisition of the lock based on the stand-by thread count information updated by the stand-by thread count information updating means and an upper limit value of the number of threads which wait according to the predetermined spinlock method.

(2) The information processing system may be configured such that the stand-by thread count information updating means atomically accesses stand-by thread count information arranged from kernel space to user space, and updates the stand-by thread count information (which is realized by using, for example, the user space atomic accessing means 233).

(3) The information processing system may be configured such that the stand-by method determining means determines the stand-by method of the thread which requests the acquisition of the lock based on the number of threads (indicated by, for example, the spinlock thread count 2213) which stand by according to a predetermined method (such as spinlock) indicated by the stand-by thread count information, and an upper limit value (such as the SPIN LIMIT value) of the number of threads which stand by according to the predetermined method set in advance, and the stand-by thread count information updating means updates the stand-by thread count information based on a determination result of the stand-by method determining means.

(4) The information processing system may be configured such that, when the thread which requests the acquisition of the lock transitions to a sleep state (which is executed, for example, by the sleep means 50), the stand-by thread count information updating means updates a stand-by thread count based on a state of the thread prior to the transition (for example, spinlock state or block state).

(5) Features of an information processing system include: a memory means (realized by, for example, the memory 200) that stores exclusive control data (realized by, for example, the lock word 221) including information (such as the lock bit 2211) showing whether or not there is a thread which is executing a critical section protected by lock, and stand-by thread count information (such as the block thread count 2212 and the spinlock thread count 2213) showing the number of threads which wait for release of the lock according to a spinlock method and a number of threads which waits for the release of the lock according to a block method; a control means (realized by, for example, the stand-by method determining means 30) that uses the stand-by thread count information as an input of an algorithm of determining as a state related to the lock of the thread a state transition destination as to transition of one of a no lock request state (such as the idle state), a lock acquisition state (such as the busy (locked) state), a lock release waiting state according to the spinlock method (such as the spinlock state), or a lock release waiting state according to the block method (such as the block state); and a stand-by thread count information updating means (realized by, for example, the stand-by thread count information updating means 10) that updates the stand-by thread count information according to state transition of the thread by the control means, and the control means executes control such that the number of threads which wait for the release of the lock according to the spinlock method does not exceed the predetermined upper limit value (such as the SPIN_LIMIT value), based on the stand-by thread count information updated by the stand-by thread count information updating means.

(6) The information processing system may be configured to have a user space atomic accessing means (realized by, for example, the user space atomic accessing means 223) that is used to execute an operation of updating exclusive control data from a kernel program (such as the kernel program 230).

Although this invention has been described with reference to the embodiment and the example, this invention is by no means limited to the above embodiments and the examples. The configuration and details of this invention can be variously changed within a scope of this invention which one of ordinary skill can understand.

This application claims priority to Japanese Patent Application No. 2010-021740 filed on Feb. 3, 2010, the entire contents of which are incorporated by reference herein.

### INDUSTRIAL APPLICABILITY

This invention is applicable for use in reducing waste of processor resources in an information processing system which execute user programs which frequently complete when a plurality of threads acquire an access right to a critical section.

### REFERENCE SIGNS LIST

10 Stand-by thread count information updating means
20 Lock acquiring means
30 Stand-by method determining means
40 Lock releasing means
50 Sleep means
60 Wake-up means
100 Processor
200 Memory
210 User program
220 User data
221 Lock word
2211 Lock bit
2212 Block thread count
2213 Spinlock thread count
230 Kernel program
231 User space reading means
232 User space writing means
233 User space atomic accessing means
240 Kernel data

1-10. (canceled)

11. An information processing system characterized in comprising:
a stand-by thread count information updating unit that updates stand-by thread count information showing a number of threads which wait for release of lock according to a spinlock method, according to state transition of a thread which requests acquisition of predetermined lock; and
a stand-by method determining unit that determines a stand-by method of a thread which requests the acquisition of the lock based on the stand-by thread count information updated by the stand-by thread count information updating unit and an upper limit value of the number of threads which wait according to the predetermined spinlock method.

12. The information processing system according to claim 11, wherein the stand-by thread count information updating unit atomically accesses stand-by thread count information arranged from kernel space to user space and updates the stand-by thread count information.

13. The information processing system according to claim 11, wherein the stand-by thread count information updating unit updates the stand-by thread count information based on a determination result of the stand-by method determining unit.

14. The information processing system according to claim 11, wherein, when the thread which requests the acquisition of the lock transitions to a sleep state, the stand-by thread count information updating unit updates a stand-by thread count based on a state of the thread prior to the transition.

15. An information processing system characterized in comprising:
a memory unit that stores exclusive control data including information showing whether or not there is a thread which is executing a critical section protected by lock, and stand-by thread count information showing a number of threads which wait for release of the lock according to a spinlock method and a number of threads which waits for the release of the lock according to a block method;
a control unit that uses the stand-by thread count information as an input of an algorithm of determining as a state related to the lock of the thread a state transition destination as to transition of one of a lock request state, a lock acquisition state, a lock release waiting state according to the spinlock method, or a lock release waiting state according to the block method; and
a stand-by thread count information updating unit that updates the stand-by thread count information according to state transition of the thread by the control unit,
characterized in that the control unit executes control such that the number of threads which wait for the release of the lock according to the spinlock method does not exceed the predetermined upper limit value, based on the stand-by thread count information updated by the stand-by thread count information updating unit.

16. The information processing system according to claim 15, further comprising a user space atomic accessing unit that is used to execute an operation of updating exclusive control data from a kernel program.

17. An exclusive control method characterized in comprising:
updating stand-by thread count information showing a number of threads which wait for release of lock according to a spinlock method, according to state transition of a thread which requests acquisition of predetermined lock; and
determining a stand-by method of a thread which requests the acquisition of the lock based on the stand-by thread count information and an upper limit value of the number of threads which wait according to the predetermined spinlock method.

18. The exclusive control method according to claim 17, further comprising atomically accessing stand-by thread count information arranged from kernel space to user space and updating the stand-by thread count information.

19. A computer readable information recording medium storing an exclusive control program, when executed by a processor, performs a method for:
stand-by thread count information updating processing of updating stand-by thread count information showing a number of threads which wait for release of lock according to a spinlock method, according to state transition of a thread which requests acquisition of predetermined lock; and
stand-by method determining processing of determining a stand-by method of a thread which requests the acquisition of the lock based on the stand-by thread count information and an upper limit value of the number of threads which wait according to the predetermined spinlock method.

20. The computer readable information recording medium storing the exclusive control program according to claim 19, further causing the computer to execute, in the stand-by thread count information updating processing, processing of atomically accessing stand-by thread count information arranged from kernel space to user space and updating the stand-by thread count information.
